(19) United States
(12) Patent Application Publication
(10) Pub. No.: US 2006/0131038 A1
(43) Pub. Date: Jun. 22, 2006

(54) Method and system for remote monitoring at a nozzle

(76) Inventor: John F. Lichtig, Bridgewater, NJ (US)

Correspondence Address: Clifford Kraft, 320 Robin Hill Dr., Naperville, IL, 60540, US

(21) Appl. No.: 10/983,210

(22) Filed: Nov. 5, 2004

Related U.S. Application Data
(60) Provisional application No. 60/518,157, filed on Nov. 7, 2003.

(51) Int. Cl. A62C 27/00; A62C 25/00; A62C 29/00

(52) U.S. Cl. 169/52

(57) ABSTRACT

A system where a sensor is placed in proximity to the nozzle of a hose to monitor pressure or other quantity. The system includes a communication link between the sensor and a remote station. Normally this is a radio link. Pressure values can be transmitted to a receiver and optional processor located near a pump. An operator can then adjust the pump to produce the desired pressure at the nozzle. Optionally, the processor can directly control the pump through a closed-loop feedback system. The communications link can use frequency or space diversity to combat fading. Radio diversity can be accomplished through the use of two or more channels. Any type of sensor can be mounted at the nozzle location.

The present invention is related to and claims priority from U.S. provisional patent application 60/518,157 filed Nov. 7, 2003. Application Ser. No. 60/518,157 is hereby incorporated by reference.

### BACKGROUND

1. Field of the Invention

The present invention is generally related to the field of remote pressure monitoring and control and more particularly to a hose pressure monitor/telemetry system.

2. Description of the Prior Art

In the use of high-pressure hoses and in particular that of fire hoses, it is very important to maintain constant water pressure at the nozzle. If the pressure changes without warning, a firefighter or other hose user will be faced with either not enough flow to perform the job or a potentially dangerous over-pressure situation. It is known in the art to provide a pressure monitor on a fire engine at the output of the pump that performs a governor operation on the pump throttle to attempt to maintain a constant pressure. This method suffers from the fact that the pressure is being monitored at the pump rather than at the nozzle. The pump operator estimates the pressure at the nozzle by taking into consideration the friction loss for the hose length (i.e., hose diameter, hose length). The friction loss itself is dependent on the water flow rate.

For the case of a flow-adjustable fog nozzle or other nozzle, if the person at the nozzle inadvertently changes (or requires more water flow but cannot communicate this to the pump operator) the water flow setting of the nozzle, there will be an overpressure or under-pressure condition. Also in fire work, a nozzle can be at a totally different elevation than that of the pump, thus requiring a correction to the pump discharge pressure (i.e., one half pound per square inch per foot of elevation). For example, a firefighter might be using a nozzle on the end of a hose that is several stories above the level of the pump (or in the alternative, below the level of the pump). Also, the hose can encounter numerous bends and other obstacles that cause the pressure to be different at the nozzle from that at the pump and very difficult to estimate.

In most fire usage, the pressure is increased or decreased only based on feedback from direct person-to-person communications with the nozzle person. This can be very dangerous because the firefighters operating the nozzle may not have sufficient water flow to extinguish the fire or protect themselves with a proper fog pattern The nozzle can have too much pressure that can fatigue the firefighters or throw them back. An overpressure situation also makes hose handling more difficult since it becomes more rigid. Not having the correct pressure also causes delays in response.

What is badly needed is a method and system for automatically and continuously monitoring pressure directly at the nozzle, relaying that information back to the pump location, and optionally performing automatic closed-loop control of the pump.

### SUMMARY OF THE INVENTION

The present invention relates to a system for remotely monitoring the pressure or other quantity at a hose nozzle that may include a pump providing liquid pressure to a nozzle, at least one sensor in proximity to the nozzle where the sensor monitors the pressure or other quantity at the nozzle, and a radio transmitter coupled to the sensor that transmits messages back to at least one central station pertaining to the nozzle pressure or other measured quantity. The present invention includes the option of closed-loop feedback control of the water pressure that using any type of sensor to monitor any quantity at a nozzle.

### DESCRIPTION OF THE FIGURES

FIG. 1 shows a hose, nozzle, pressure transducer and radio system.

FIG. 2 shows a space diversity antenna arrangement.

FIG. 3 shows a hose pressure transducer and an additional pressure transducer located at a discharge location.

Several figures and illustrations have been presented to aid in the understanding of the present invention. The scope of the present invention is not limited to what is shown in the figures.

### DETAILED DESCRIPTION OF THE INVENTION

The present invention relates to a method and system to directly measure water pressure at a nozzle (in particular, a fire hose nozzle) and provide this information at the pump panel for use by the pump operator, or provide this information to other locations, or optionally automatically control a pump through a closed-loop feedback arrangement. In the manual case, the pump operator can read the pressure and manually adjust the pump. In the automatic case, a feedback loop can maintain a constant desired pressure at the nozzle. The present invention also provides optionally additional pressure monitoring locations (such as at the pump discharge) to locate problems in the system such as kinks in the hose and leaks. These problems can be diagnosed by reporting the differential pressure between the pump discharge and the nozzle. A pressure sensor can also be used at the pump intake to provide that pressure to a relay fire engine providing a continuous water supply.

The present invention normally uses wireless communications between the nozzle and a receiver unit located near the pump preferably on the fire engine. The communications should preferably be by wireless such as radio in a frequency band that is not primarily line-of-sight. While infrared or microwave line-of-sight communications could be used in some situations, these techniques would not generally be useful in a fire situation with firefighters inside a building. It is also within the scope of the present invention to use electrical communication such as a wire running with the hose as shown in U.S. Pat. No. 5,044,445). However, this method suffers from the danger of a broken wire in a harsh hose environment and requires somehow attaching a wire to the hose.

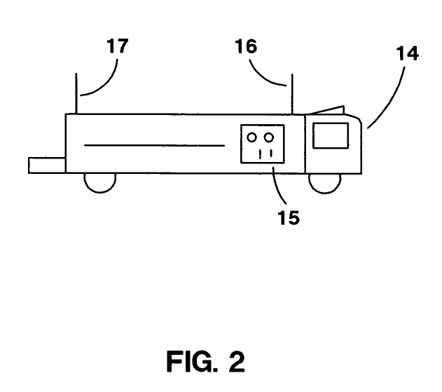

A single channel or multiple RF radio channels can be used with the present invention. While the invention will work with one channel, it is desirable to have two or more channels to achieve diversity. Diversity increases the system's resistance to fading. Fading occurs with a single radio channel when the radio-wave travels from the transmitter to the receiver by more than one path (multi-path reception). In this case, the radio signal can reflect from objects resulting in a reflected wave and a direct wave (or two reflected waves) arriving at the receiver at different times. In some cases, the time difference is sufficient to create an approximately 180 degree phase shift between the two signals This causes a total cancellation of the signal. This is known as a deep fade. FIG. 2 shows a fire engine with 14 with a front-mounted receiving antenna 16 and a rear-mounted receiving antenna 17 for space diversity. It should be noted that all communication links can be two-way. This allows reverse communication back out to the nozzle sensor or to the hose operator. Such a link could be used for two-way voice communication as well as telemetry. It is possible to use a “smarter” module at the module with more than one sensor and its own controller. Two-way communication with such a module would be desirable in certain embodiments of the present invention.

Diversity communication uses at least two separate transmitting or receiving antenna locations or different frequencies to minimize this fade problem. It is within the scope of the present invention to use any type of diversity method or none at all. The preferred method is to transmit simultaneously on two different radio channels (i.e., separated in frequency). This type of diversity causes fading to occur at different physical locations for each channel. Thus, if one channel is faded, there is a high probability that the other is not. The method of having multiple receiving antennas is also possible. For example, a fire vehicle could have two receiving antennas (say one on the front of the truck or top of the cab and one on the rear of the truck). This type of diversity (also known as space diversity) accomplishes the same result (makes the system more immune to fading as the transmitter moves around).

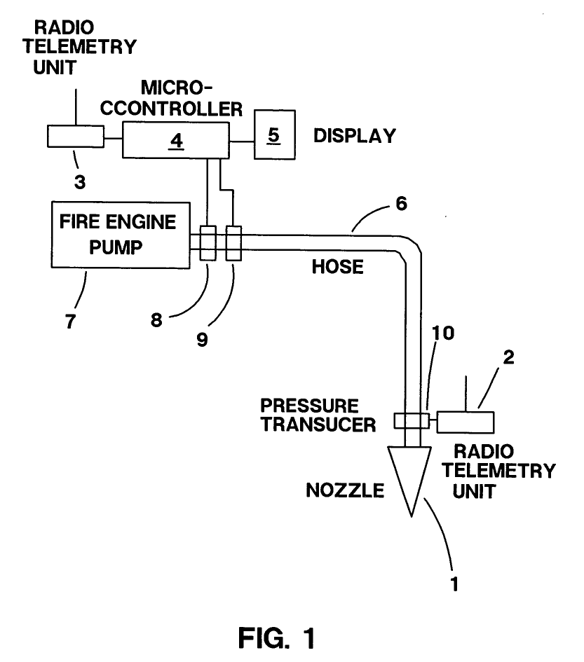

FIG. 1 shows an embodiment of the present invention. A pressure transducer 10 is mounted in the nozzle 1 in or near its inlet or in the hose 6 just before it enters the nozzle 1. The pressure transducer 10 can also be in the form of a universal adaptor installed between the hose end coupler and the nozzle. A radio transmitter 2 with an antenna is also mounted on or in the nozzle, or on the hose near the nozzle. This transmitter should preferably be battery powered and very rugged. A typical pressure transducer is Omega Engineering, Inc. PX4100-600GV. A typical display unit is Omega Engineering, Inc. DPIS32. A possible commercially available radio system (or receiver) is Omega Engineering, Inc. RT400T (transmitter module) and RT400R (receiver module). While these particular units can be used, numerous other sensors, displays and radios are within the scope of the present invention.

At the fire engine or other pump location, at least one radio receiver 3 receives signals from the nozzle transmitter 2. An optional controller 4 can drive a display 5 that shows that pressure visually, and can optionally control a proportioning valve 8 automatically. The proportioning valve 8 normally controls the flow of water into a hose 6. An alternate method (not shown) is to have a microcontroller 4 directly control the throttle of the fire truck pump 7. It should be understood that any method of controlling the pump, or displaying the nozzle or hose pressure, is within the scope of the present invention. An additional, optional flow meter 9 can report the flow rate to the processor 4. The processor 4 can also optionally measure pressure at the pump discharge. The controller 4 can be any processor including a microcontroller, microprocessor, PC or any other type of computer or processor.

There are some fire engine manufacturers who use a system called a “pressure governor.” This system monitors the water pressure at the main pump discharge on the fire engine. Once a target pressure is set by the operator, the pressure governor will increase or decrease the engine speed to maintain the target pressure. The present invention can improve that system by providing the actual pressure at the nozzle instead of the pressure at the main pump discharge. Without actual knowledge of nozzle pressure, friction loss can cause errors in a pressure governor system. If the nozzle person changes (increases) the water flow setting on the nozzle, more water tends to flow, reducing the pressure at the pump discharge. The pressure governor tries to correct this pressure, but the actual water flow at the nozzle will be incorrect because the increased water flow also increases the friction loss provided by the hose, and this factor is not taken into account by the pressure governor because of its pressure monitoring location. With actual nozzle pressure information, this problem is eliminated no matter what the instantaneous hose friction loss is.

The present invention is particularly useful during the first critical minutes upon arrival at a fire scene. The pump operator is extremely busy establishing a proper water supply to the firefighters at the nozzle of the initial attack hose line(s). During these critical minutes, the driver must 1) put the fire engine into pump gear; 2) chock the wheels, 3) open the tank-to-pump gate, 4) throttle up to develop pressure at the pump discharge, 5) re-circulate water to prevent the pump from overheating, 6) open the gate (valve) to the attack line(s), 7) open the discharge gate to get water to the nozzle, 8) set the over-pressure relief valve, 9) coordinate setting up a continuous water supply (e.g., fire hydrant, second-due fire engine) to the fire engine, 10) bleed the air from the continuous supply line, 11) transition the pump water inlet from the truck tank to the intake by gating both sources simultaneously (i.e., close one while opening the other), 12) fill the tank with the continuous water supply, and 13) if more than one attack line is used, monitor the discharge pressure gauges to gate the discharge as nozzles are opened and closed.

The pump operator must also monitor the radio to ascertain if any attack line is having pressure problems and try to adjust the gating or pump accordingly. The present invention can help in these critical minutes by providing real-time reporting of pressure at the attack end of each of the hoses. In this early stage, the entire operation can remain manual. After the flow becomes steady to each attack line, the pump operator can switch that line to the automatic mode of the present invention so that nozzle pressure is maintained automatically. This frees up the operator to attend to the other essential tasks such as coordinating a continuous water supply.

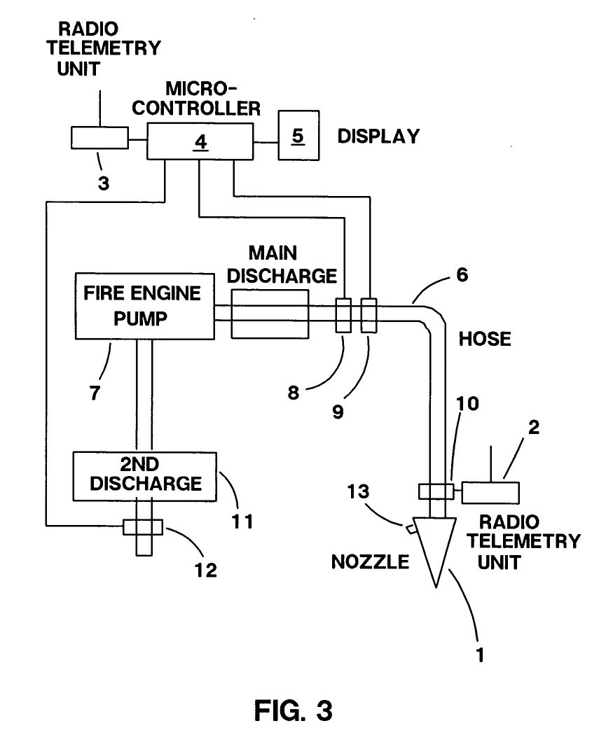

As previously stated, the present invention can optionally have a two-way communications radio also incorporated into the nozzle unit to provide easy communication between the nozzle person and the pump operator. A push-to-talk (PTT) button 13 (shown in FIG. 3) can be incorporated on the nozzle unit so the firefighter does not have to remove one hand from the nozzle to talk to the pump operator or the fire scene incident commander. Optionally, a voice activated (voice to talk) switch can be used.

Also as stated before, an additional pressure sensor can be added at the pump discharge so that kinks and leaks on the hose can be quickly assessed. This can be accomplished by comparing the differential pressure between the pump discharge and the nozzle, taking into account the friction loss of the hose. If there is a kink in the hose, the differential pressure will be higher than normal taking into account the expected pressure loss along the hose due to friction loss. The processor can automatically calculate the expected differential pressure and determine if there is a kink in the hose, and generate and alarm or take other action. FIG. 2 shows an embodiment of the present invention similar to that shown on FIG. 1. Here a pump discharge 11 is equipped with a pressure sensor 12 that also feeds back pressure information to the processor 4.

It should be particularly noted that the present invention can be used with multiple nozzles and multiple firefighters. In the case of multiple nozzles, the processor is particularly useful in monitoring and/or controlling the pressure and flow at each nozzle independently.

It should also be noted that the present invention can be used in a much wider context than just that of fire hose pressure sensing. Any number or type of sensor can be mounted at the remote end of the hose or on or in the nozzle. Examples of these diverse sensors 10 could include toxic gas sensors, heat or temperature sensors and a video camera. Any sensor that can be mounted on or in proximity to the nozzle is within the scope of the present invention.

The present invention has been described by various written descriptions and illustrations. It will be recognized by one of skill in the art that numerous changes and variations are possible. All of these changes and variations are within the scope of the present invention.

I claim:

1. A system for remotely monitoring the pressure at a hose nozzle comprising:
a pump providing liquid pressure to a nozzle;
a pressure sensor in proximity to said nozzle monitoring pressure at said nozzle;
a transmitter coupled to said pressure sensor transmitting messages pertaining to said pressure;
a receiver receiving said messages from said transmitter and reporting said pressure.

2. The system of claim 1 wherein said transmitter is a wireless transmitter.

3. The system of claim 1 further comprising a closed feedback loop, said closed feedback loop receiving pressure information from said receiver and controlling said pressure.

4. The system of claim 2 further comprising transmitting said messages on at least two different radio frequencies.

5. The system of claim 2 further comprising said radio receiver having at least two separate antennas.

6. The system of claim 1 further comprising additionally monitoring pressure at a discharge.

7. The system of claim 1 further comprising a processor in electrical communication with said receiver.

8. The system of claim 7 wherein said processor reports said pressure on a display.

9. A method of maintaining correct pressure at the nozzle end of a hose comprising the steps of:
providing a pressure sensor in proximity to said nozzle;
providing a means for communication from said nozzle to a remote location;
transmitting current pressure values over said means of communication to said remote location;
using said pressure values at said remote location to maintain a correct pressure at said nozzle.

10. The method of claim 9 wherein said pressure values are received by a receiver apparatus located in proximity to a pump.

11. The method of claim 10 further comprising a processor in electrical communication with said receiver apparatus.

12. The method of claim 11 wherein said processor automatically controls pressure in said hose based on feedback from said pressure sensor.

13. The method of claim 9 wherein said pressure values are transmitted to said remote location over a radio link.

14. The method of claim 13 wherein said radio link uses at least two frequencies.

15. The method of claim 10 wherein said receiver apparatus is a radio receiver with more than one receive antenna location.

16. The method of claim 9 further comprising additionally monitoring pressure at a discharge point.

17. A fire hose water pressure monitoring system for monitoring and controlling water pressure at a fire hose nozzle comprising, in combination:
a pressure sensor for measuring said water pressure, said pressure sensor located near said nozzle;
a radio transmitter coupled to said pressure sensor for transmitting a signal representative of a pressure value to a remote location;
at least one radio receiver remote from said nozzle for receiving a transmission from said radio transmitter, said receiver receiving said signal representative of said pressure value;
a processor in electrical communication with said receiver, said processor presenting said pressure value so that pressure can be controlled.

18. The system of claim 17 wherein said radio transmitter transmits on two radio channels of different frequencies.

19. The system of claim 17 wherein said radio receiver has more than one antenna.

20. The system of 17 wherein said processor controls said pressure in a closed loop configuration.

21. The system of claim 17 further comprising at least one additional sensor reporting back a quantity value over said radio transmitter.
